(19) United States
(12) Patent Application Publication
(10) Pub. No.: US 2010/0307290 A1
(43) Pub. Date: Dec. 9, 2010

(54) Apparatus, system and method for gyroscopic propulsion and/or steering

(76) Inventor: Konstantinos Porfiropoulos, Chicago, IL (US)

Correspondence Address: PATENTS+TMS, P.C., 2849 W. ARMITAGE AVE., CHICAGO, IL, 60647, US

(21) Appl. No.: 12/462,531

(22) Filed: Aug. 3, 2009

Related U.S. Application Data
(60) Provisional application No. 61/268,106, filed on Jun. 9, 2009.

(51) Int. Cl. F16H 33/20; F03G 3/00; G01C 19/02

(52) U.S. Cl. 74/84 R

(57) ABSTRACT

An apparatus, system and method provide gyroscopic propulsion and steering. Specifically, an apparatus, system and method provide inertial or gyroscopic propulsion utilizing the torque of rotating discs and/or weights to create an angular spin or precession. More specifically, rotation of a plurality of discs and/or weights on axes of rotation rotating around a major central axis of rotation creates a net force in a particular direction, allowing for propulsion and/or steering in that direction.

### BACKGROUND OF THE INVENTION

The present invention generally relates to an apparatus, system and method for gyroscopic propulsion and/or steering. Specifically, the present invention relates to an apparatus, system and method for gyroscopic propulsion utilizing the torque of gyroscopic discs or weights to create an angular spin and precessional force. More specifically, high speed rotation of a plurality of discs and/or weights on axes of rotation further rotating around a major central axis of rotation creates a net force in a particular direction, allowing for propulsion and/or steering in that direction.

It is generally known to produce propulsion by means of engines, rockets, electrical energy and the like. Typically, propulsion by these methods is relatively inefficient, in that large amounts of energy must be utilized to create propulsive forces. In addition, a large amount of fuel must be utilized to create these propulsive forces. For example, rockets must carry large fuel tanks for combusting to create the necessary propulsion. Moreover, steering is typically controlled by deflecting linear forward motion, or creating side-to-side propulsive forces that interact with forward or backward propulsive forces. Again, however, steering a body in this manner is relatively inefficient.

Moreover, gyroscopes are known. A gyroscope, generally, is a device for measuring or maintaining orientation, based on the principles of angular momentum. Generally, the device is a spinning wheel or disk whose axle is free to take any orientation. This orientation changes much less in response to a given external torque than it would without the large angular momentum associated with the gyroscope's high rate of spin.

The behavior of a gyroscope can be most easily appreciated by consideration of the front wheel of a bicycle. If the wheel is leaned away from the vertical so that the top of the wheel moves to the left, the forward rim of the wheel also turns to the left. In other words, rotation on one axis of the turning wheel produces rotation of the third axis.

A gyroscope flywheel will roll or resist about the output axis depending upon whether output gimbals are of a free or fixed configuration. Examples of some free-output-gimbal devices would be the attitude reference gyroscopes used to sense or measure the pitch, roll and yaw attitude angles in a spacecraft or aircraft. The center of gravity of the rotor can be in a fixed position. The rotor simultaneously spins about one axis and is capable of oscillating about the two other axes, and thus, except for its inherent resistance due to rotor spin, it is free to turn in any direction about the fixed point.

Using fixed-position rotors, it is generally known to utilize one or more gyroscopes to create a net force in a direction. This net force may be used for propulsion and steering. For example, U.S. Pat. No. 3,979,961 to Schnur relates to a device where a liquid is rotated in a centrifuge creating a net force in the direction of propulsion. Specifically, a quantity of liquid is rotated within an annular housing to centrifugally distribute the liquid thereabout in an annular channel. A deflection device is mounted within the housing and deflects the liquid inwardly from the annular channel at a predetermined position relative to an outside reference thereby creating an unbalanced centrifugal force which unidirectionally propels the apparatus with continuous motion. However, the utilization of liquid for the purpose of achieving a net force in the direction of propulsion is cumbersome, may leak and lacks control.

Moreover, U.S. Pat. No. 4,409,856 to de Weaver III demonstrates how rotational motion can achieve movement of a body in a single direction. The propulsion system, as described by de Weaver III, utilizes a frame, a pair of counter-rotating lower members rotatably mounted to the frame and positioned above the lower members, each at an angle to the disk so that each contacts a surface of the members below it at a single point, and a motor and drive train for driving the lower members. Each lower member includes a pair of studs mounted at its periphery which engage radially extending posts mounted to its corresponding upper cylinder so that rotation of the lower member causes the upper member to rotate in the way, but damped and at the same angular velocity. The super position of the damped upper members upon the damped lower members generates unbalanced centrifugal forces which results in a constant unidirectional resultant force.

Further developing this approach, U.S. Pat. Nos. 6,234,267 and 6,612,934, both to Foster, Sr., demonstrate devices and systems for conserving applied energy using reaction control devices that act in conjunction with normal methods of propulsion, theoretically saving fuel consumption of an object under propulsion.

U.S. Pat. No. 4,784,006 to Kethley demonstrates a gyroscopic propulsion device including a rotatable body in which the center of mass of the rotating body is offset away from a first axis to a second axis. The body rotating around the eccentric second axis of the rotating body generates a propulsion force which moves a vehicle to which the device is attached.

U.S. Pat. No. 5,024,112 to Kidd demonstrates a gyroscopic apparatus that is comprised of a pair of spinning discs disposed opposite one another with arms rotatably supporting the discs connected to a pivot point, the pivot axis thereof lying in a plane midway between the discs. A drive arrangement operates to spin the discs in opposite directions while simultaneously rotating the whole assembly of discs and arms about a second axis in the same plane as, but perpendicular to, the pivot axis. A camming arrangement working in conjunction with the rotation about the second axis periodically forces the spinning discs to pivot about the pivot axis to thereby generate a force along the second axis which can be used to perform useful work.

While it is known to provide propulsion and steering utilizing gyroscopic devices, the patents described herein do not allow for a relatively small set of inertial drives on the rotating bodies. They further lack control and do not provide the ability to smoothly effectuate forward propulsion or steering.

A need, therefore, exists for an apparatus, system and method for generating propulsion and/or steering using gyroscopic devices. More specifically, a need exists for an apparatus, system and method for generating propulsion and/or steering utilizing a plurality of discs and/or weights rotating about a plurality of axes.

Moreover, a need exists for an apparatus, system and method for generating propulsion and/or steering of a body utilizing a plurality of discs and/or weights rotating about a plurality of axes, wherein the propulsion and/or steering is achieved by rotation of the weights around the plurality of axes, relative to each other.

In addition, a need exists for an apparatus, system and method for generating propulsion and/or steering of a body utilizing a plurality of discs and/or weights rotating about a plurality of axes, each of the rotating plurality of discs and/or weights further rotating about a major axis, providing a net force in particular direction.

Further, a need exists for an apparatus, system and method for generating propulsion and/or steering of a body, wherein the propulsion and steering is achieved via a rotation around a major axis that is adding a precessional force to a net centrifugal force.

Still further, a need exists for an apparatus, system and method for generating propulsion and/or steering of a body wherein the body is a vehicle needing propulsion and/or steering in two-dimensions, such as an automobile, a boat and the like, or in three-dimensions, such as a submarine or a spaceship.

### SUMMARY OF THE INVENTION

The present invention generally relates to an apparatus, system and method for gyroscopic propulsion and/or steering. Specifically, the present invention relates to an apparatus, system and method for gyroscopic propulsion utilizing the torque of gyroscopic discs or weights to create an angular spin and precessional force. More specifically, high speed rotation of a plurality of discs and/or weights on axes of rotation further rotating around a major central axis of rotation creates a net force in a particular direction, allowing for propulsion and/or steering in that direction.

To this end, in an embodiment of the present invention, a gyroscopic propulsion and steering apparatus is provided. The apparatus comprises a base; a shaft disposed longitudinally from the base, the shaft being rotatable about a central axis; and a plurality of arms disposed laterally from the shaft, each arm having a group of rods disposed on the end thereof, each rod having a weight disposed on the end thereof, wherein each of the groups of rods and weights has a respective axis of rotation and further wherein each of the groups of rods and the weights thereon rotate around its respective axis.

In an embodiment, the apparatus comprises a motor for rotating each of the groups of rods and weights.

In an embodiment, the apparatus comprises a motor for rotating the shaft.

In an embodiment, the apparatus comprises a motor for rotating both each of the groups of rods and weights and for rotating the shaft.

In an embodiment, each of the arms is positioned equidistantly around the shaft.

In an embodiment, the apparatus comprises a lever connected to each group of rods and weights for changing the position of the respective axis of rotation for each of the groups of rods and weights.

In an embodiment, the shaft is disposed through the base and rotates while the base remains stationary with respect to the shaft.

In an embodiment of the present invention, a gyroscopic propulsion and steering system is provided. The system comprises a vehicle; and a gyroscopic propulsion and steering apparatus comprising a base attached to the vehicle, a shaft disposed longitudinally from the base, a plurality of arms disposed laterally from the shaft, each arm having a group of rods disposed on the end thereof, each rod having a weight disposed on the end thereof, wherein each of the groups of rods and the weights has a respective axis of rotation and further wherein each of the groups of rods and the weights thereon rotates around its respective axis.

In an embodiment, the apparatus further comprises a motor for rotating each of the groups of rods and weights.

In an embodiment, the apparatus further comprises a motor for rotating the shaft.

In an embodiment, the apparatus further comprises a motor for rotating the shaft and each of the groups of rods and weights.

In an embodiment, each of the arms is positioned equidistantly around the shaft.

In an embodiment, the system further comprises a lever connected to each group of rods and weights for changing the position of the respective axis of rotation for each of the groups of rods and weights.

In an embodiment, the shaft is disposed through the base and rotates while the base remains stationary with respect to the shaft.

In an embodiment of the present invention, a method of propelling and steering a vehicle is provided. The method comprises the steps of providing a gyroscopic propulsion and steering apparatus attached to a vehicle, the apparatus comprising a base attached to the vehicle, a shaft disposed longitudinally from the base and having a central axis of rotation, a plurality of arms disposed laterally from the shaft, each arm having a group of rods disposed on the end thereof, each rod having a weight disposed on the end thereof, wherein each of the groups of rods and the weights has an axis of rotation; rotating the plurality of groups of rods and weights around each respective axis; and rotating the shaft around the central axis.

In an embodiment, the method further comprises providing a motor mechanically connected to the plurality of groups of rods and weights; and rotating the plurality of groups of rods and weights via the motor.

In an embodiment, the apparatus has a top and further the method comprises disposing the top of the apparatus in a first direction to propel the vehicle in the first direction.

In an embodiment, each of the groups of rods and weights has a lever for changing the position of each respective axis of rotation for the groups of rods and weight, and further wherein the method comprises changing the positions of the respective axes of rotation to propel the apparatus in a direction.

In an embodiment, the method further comprises disposing a second gyroscopic propulsion and steering apparatus attached to the vehicle, the apparatus comprising a base attached to the vehicle, a shaft disposed longitudinally from the base, a plurality of arms disposed laterally from the shaft, each arm having a group of rods disposed on the end thereof, each rod having a weight disposed on the end thereof, wherein each of the groups of rods and the weights has an axis of rotation and further wherein each of the groups of rods and the weights thereon rotate around its respective axis; propelling the vehicle in a first direction using the first apparatus; and propelling the vehicle in a second direction using the second apparatus.

In an embodiment, the method further comprises disposing a plurality of gyroscopic propulsion and steering apparatuses in the vehicle, wherein each of the apparatuses comprises a base attached to the vehicle, a shaft disposed longitudinally from the base, a plurality of arms disposed laterally from the shaft, each arm having a group of rods disposed on the end thereof, each rod having a weight disposed on the end thereof, wherein each of the groups of rods and the weights has an axis of rotation and further wherein each of the groups of rods and the weights thereon rotate around its respective axis; and steering the vehicle through three-dimensional space using the plurality of apparatuses.

It is, therefore, an advantage to provide an apparatus, system and method for generating propulsion and/or steering using gyroscopic devices. More specifically, it is an advantage to provide an apparatus, system and method for generating propulsion and/or steering utilizing one or a plurality of weights rotating about respective axes of rotation.

Moreover, it is an advantage to provide an apparatus, system and method for generating propulsion and/or steering of a body and/or a vehicle utilizing a plurality of weights rotating about a plurality of respective axes, wherein the propulsion and/or steering is achieved by rotation of the weights around the plurality of axes, relative to each other.

In addition, it is an advantage to provide an apparatus, system and method for generating propulsion and/or steering of a body utilizing a plurality of weights rotating about a plurality of respective axes, each of the rotating discs and/or weights further rotating about a major central axis, providing a net force in a particular direction.

Further, it is an advantage to provide an apparatus, system and method for generating propulsion and/or steering of a body, wherein the propulsion and steering is achieved via a rotation around a major axis that is adding a precessional force to a net centrifugal force.

Still further, it is an advantage to provide an apparatus, system and method for generating propulsion and/or steering of a body wherein the body is a vehicle needing propulsion and/or steering in two-dimensions, such as an automobile, a boat and the like, or in three-dimensions, such as a submarine or a spaceship.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of an apparatus for providing gyroscopic propulsion and/or steering, in an embodiment of the present invention.

FIG. 2 illustrates a top plan view of the apparatus for providing gyroscopic propulsion and/or steering, in an embodiment of the present invention.

FIG. 3 illustrates a cross-sectional view of the apparatus for providing gyroscopic propulsion and/or steering, in an embodiment of the present invention.

FIG. 4 illustrates a side view of an apparatus for providing gyroscopic propulsion and/or steering, in an alternate embodiment of the present invention.

FIG. 5 illustrates a side view of an apparatus for providing gyroscopic propulsion and/or steering utilizing asymmetric rotation of weights about a major axis of rotation.

### DETAILED DESCRIPTION OF THE PRESENTLY PREFERRED EMBODIMENTS

The present invention generally relates to an apparatus, system and method for gyroscopic propulsion and/or steering. Specifically, the present invention relates to an apparatus, system and method for gyroscopic propulsion utilizing the torque of gyroscopic discs or weights to create an angular spin and precessional force. More specifically, high speed rotation of a plurality of discs and/or weights on axes of rotation further rotating around a major central axis of rotation creates a net force in a particular direction, allowing for propulsion and/or steering in that direction.

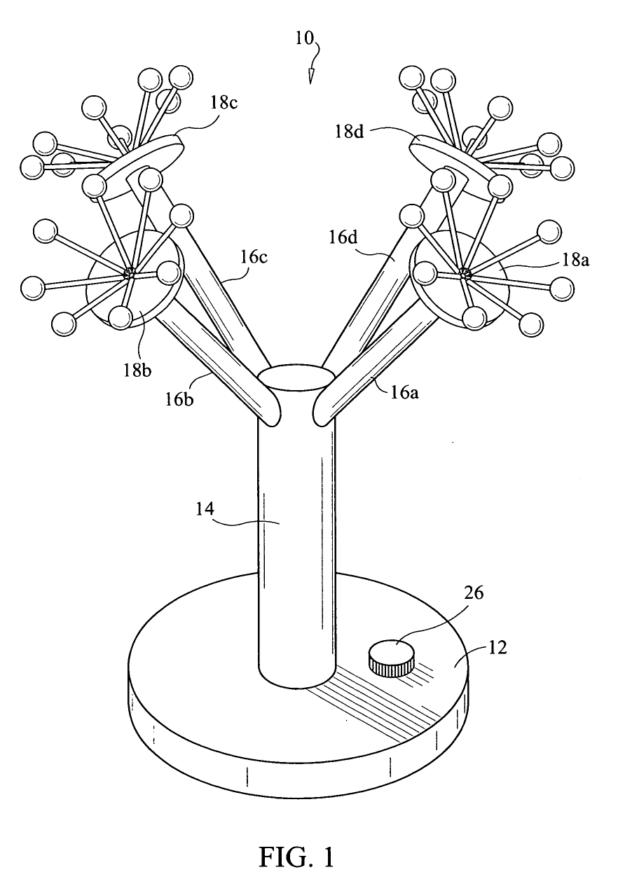

Now referring to the figures, wherein like numerals refer to like parts, an apparatus 10 is provided, as illustrated in FIGS. 1-3. The apparatus 10 may comprise a base 12, a shaft 14 disposed vertically through the base 12. The shaft 14 may be cylindrical. The apparatus 10 further may comprise a plurality of arms 16a, 16b, 16c and 16d extending laterally and generally vertically from the shaft 14.

Attached to each of the arms 16a, 16b, 16c and 16d may be a disc, illustrated in FIG. 1 as 18a, 18b, 18c and 18d. Preferably, each of the arms 16a, 16b, 16c and 16d may be equidistant from the shaft 14 and equiangular from each other, thereby extending from the shaft 14 in a plurality of different directions relative to the shaft 14.

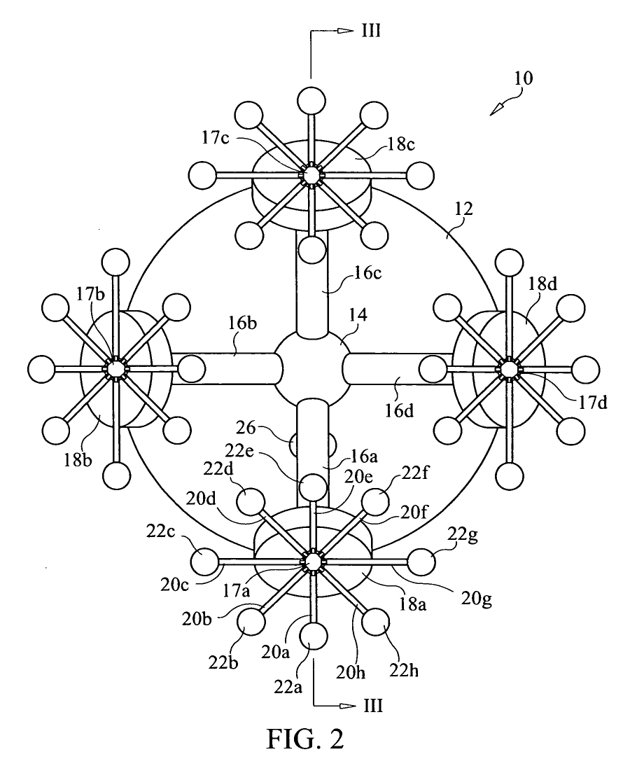

A plurality of rods may be further attached to each of the arms 16a, 16b, 16c and 16d, as illustrated in FIGS. 1-3. 3. As illustrated in FIG. 2, arm 16a may include eight rods labeled 20a, 20b, 20c, 20d, 20e, 20f, 20g and 20h, respectively. The rods 20a-20h may be attached to the arm 16a via connector 17a, extending from the arm 16a, as illustrated in FIG. 2. Preferably, each of the rods 20a-20h may be hingedly attached to the connector 17a. Each of the remaining arms 16b, 16c and 16d may have a plurality of rods that may be attached in the same manner as the rods 20a-20h may be attached to the arm 16a via the connectors 17b, 17c and 17d. It should also be noted that any number of rods may be disposed on each of the arms, and the invention should not be limited as described herein. Further, it should be noted that each of the arms may or may not have the plurality of discs 18a, 18b, 18c and 18d. The discs 18a, 18b, 18c and 18d may be utilized as guards or holders for the plurality of rods, as described above, to keep the rods from extending beyond the discs and for control of the rods during rotation thereof, as described below.

Attached to each of the rods 20a-20h may be a weight, illustrated in FIG. 1 as 22a, 22b, 22c, 22d, 22e, 22f, 22g and 22h, respectively. Preferably, the weights may be of equal weight and size. However, the weights may be of unequal weight, size and shape as well, and the invention should not be limited as described herein. Rotation of the weights, as described below, provides outwardly disposed centrifugal force when rotated about an axis. An equal distribution of weights rotating at the same speed at the same angle relative to the shaft 14 may produce an equal outward centrifugal force as the weights rotate about the axis.

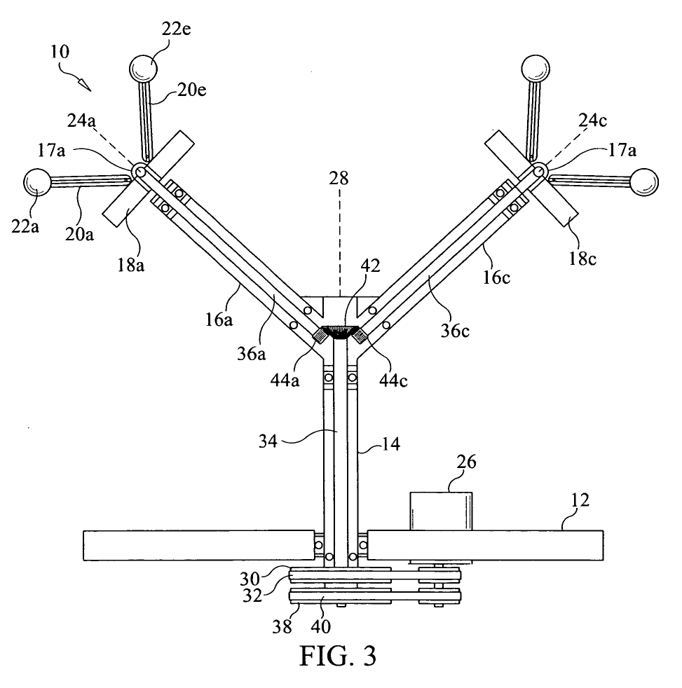

In an embodiment of the present invention, as illustrated in FIGS. 1-3, each of the groupings of weights on each arm 16a, 16b, 16c and 16d may rotate about an axis generally in line with each of the arms. FIG. 3, representing a cross-sectional view of the apparatus 10 along line III-III in FIG. 2, illustrates the axis of rotation for two of the arms 16a, 16c, designated as dashed lines 24a and 24c. It should be noted that the other two arms, 16b, 16d also may have axes of rotation not illustrated in FIG. 3. The axes of rotation 24a, 24c may be disposed in different directions, but generally laterally and upwardly from the shaft 14.

Rotation of the rods and the weights may cause a gyroscopic effect as the rods and weights rotate about their respective axes of rotation. The rotation of the weights and rods may be caused by motor 26 disposed on, in or near the base 12, and can be further seen as illustrated in FIGS. 2 and 3, as described below. It should be noted that the motor 26 may be disposed in any location apparent to one having ordinary skill in the art to provide rotation of the rods and weights, respectively.

The shaft 14 of the apparatus 10 may also rotate around a central axis, designated in FIG. 3 as central axis 28, causing each of the arms 16a, 16b, 16c and 16d to rotate around the central axis 28. Of course, the groupings of weights on each arm 16a, 16b, 16c and 16d may each rotate about their own axis of rotation at the same time as the arms 16a, 16b, 16c and 16d are rotating about the central axis 28.

Without being bound by theory, it is believed that rotation of the shaft 14 about the central axis 28 may cause a forced deflection of each of the gyroscopes that may be created by rotation of the groups of weights on each of the arms 16a, 16b, 16c and 16d, thereby causing a net force in a particular direction. The particular direction in the embodiment illustrated in FIGS. 1-3 may be vertical. The shaft 14 may rotate due to the motor 26. The mechanics of the rotation caused by the motor 26 is further illustrated in FIG. 3.

In a preferred embodiment, rotation of the shaft 14 and each of the groups of weights, may be caused by a single motor 26, as illustrated in FIG. 3. However, two or more motors may be utilized to drive each of the rotating parts of the present invention, as apparent to one having ordinary skill in the art. With enough rotational speed of each of the groups of weights, as well as the shaft 14, a significant force may be generated in the vertical direction.

While the invention has been described herein with four arms, 16a, 16b, 16c and 16d, it should be noted that more or less arms may be utilized for the present invention, and the invention should not be limited as herein described. With the additional arms, there may be rods and weights attached to each of the additional arms, as generally described herein. When rotating, these further gyroscopes may affect the net force when deflected by rotation of the shaft 14. Preferably, the number of arms may be disposed around the shaft 14 such that the distribution of weights may be balanced when rotating. This may allow the net force to be maintained smoothly. Therefore, the arms, discs, rods and weights may be disposed in such as way as to be balanced in the apparatus 10.

While the apparatus may be made from any material apparent to one having ordinary skill in the art, it is preferred that the apparatus be as light as possible, with the exception of the weights disposed on each of the rods that may cause the gyroscopic effect when rotating. However, it is contemplated that the net force generated by the apparatus 10 may be ideally suited for space travel, where weight factors may be minimized due to weightlessness of a vehicle in space.

Still referring to FIG. 3, the shaft 14 may be connected to a wheel 30, connected by belt 32 to the motor 26. The speed of the rotation of the shaft 14 may be controlled by the motor 26, and should the speed be desired to change, the motor speed may be changed and/or a gear system may be introduced to change the motor speed.

The motor 26 may be any motor apparent to one having ordinary skill in the art to provide rotation to the various moving parts of the apparatus 10. Preferably, the motor may be an electric motor, but other motors may further be utilized without detracting from the present invention.

The shaft 14 has an internal shaft 34 that may drive the rotation of internal arm shafts 36a and 36c. It should be noted that while FIG. 3 illustrates only two of the arms of the apparatus 10, the other arms not shown may have internal arm shafts connected in a same or a similar manner.

The internal shaft 34 may be connected to a second wheel 38 and belt 40, which may also be driven by the motor 26. Rotation of the internal shaft 34 may cause rotation of the internal arm shafts 36a, 36c via mechanical transfer via gears. Specifically, internal shaft 34 may terminate with a tapered gear 42 engaging gears 44a, 44c on each of the internal arm shafts 36a, 36c, respectively. The internal arm shafts 36a, 36c, as illustrated in FIG. 3, may be connected to the connectors 17a, 17c, respectively. Rotation of the internal arm shafts 36a, 36c may cause rotation of the connectors 17a, 17c, which may cause rotation of the rods 20a, 20e and weights 22a, 22e. Of course, the other rods and weights, not shown, may also rotate via rotation of the arm shafts 36a, 36c. Further, the other arms not shown in FIG. 3 may have similar parts causing rotation of their respective rods and weights.

Preferably, the rods 20a, 20e, as well as the other rods not shown in FIG. 3, may be hingedly attached to the connector 17a. This allows the rods to move outward or toward the axis of rotation 24a, depending on the speed of the rotation of the disc 18a. By providing this freedom, the rods 20a, 20e as well as the weights 22a, 22e may naturally fall into a balanced position when rotating and creating a centrifugal force, thereby providing more efficient and smooth net force in the desired direction. For example, if the weights spin at a particular speed, this may cause the rods 20a, 20e and hence, the weights 22a, 22e to fall naturally into a particular position based on the centrifugal forces, relative to the axis of rotation 24a. In addition, rotation of the shaft 14 further may cause the rods and weights to naturally fall into a particular position, maximizing the force in the particular direction.

As noted above, rotation of the rods and weights of the apparatus 10 may create four gyroscopes. Preferably, the rods and weights each may spin in the same direction, such as clockwise or counter-clockwise at the same speed. Therefore, it is preferable that each of the discs may be rotated by the same motor 26, as illustrated in FIG. 3. However, it should be noted that each gyroscope may be rotated independently of the other. Moreover, each gyroscope may rotate either clockwise or counter-clockwise irrespective of the direction of rotation of the other gyroscopes. While it is preferred that each gyroscope may rotate at the same speed, each gyroscope may rotate at different speeds. Rotation of each of the four gyroscopes along their axes of rotation, along with rotation about the central axis 28 may cause a net force of the apparatus in the vertical direction.

Many aspects of the invention may be changed to optimize the net force that may be created by the rotation of the various parts. Specifically, the weights on each of the rods may be made heavier or lighter and, as noted above, may be any shape. It is understood that heavier weights may cause a larger centrifugal force when rotation, thereby causing a larger net force in the vertical direction. In addition, the length of the rods may be changed—longer rods may cause an increase in torque as the weights spin. In addition, the speed of the rotation of the rods and weights may change as well. Further, the lengths of the arms may be increased or decreased. Moreover, the speed of the rotation of the shaft 14 may be changed. Each of these independent elements may be changed to optimize the net force and the control thereof. One having ordinary skill in the art may optimize the apparatus 10 by making these changes without undue experimentation.

As illustrated in FIGS. 1-3, the net force may be in the vertical direction, generally in the direction of the central axis 28. However, it should be noted that the apparatus 10 may be turned on its side to provide propulsion in a particular horizontal direction as well, with the force disposed in the direction of the central axis 28 that may be disposed horizontally. Therefore, one or more of the apparatus 10 may be utilized to provide propulsion and steering in particular directions. For example, a single apparatus 10 may be utilized to propel a vehicle in a desired direction of travel by disposing the entire apparatus 10 in the desired direction of travel. Simply turning the apparatus and changing the disposing of the central axis of rotation 28 may cause the vehicle to turn in the direction desired.

Alternatively, a plurality of apparatuses 10, as described herein, may be utilized to cause propulsion and/or steering. More specifically, the plurality of apparatuses 10 may each have a relative net force and may be “pointed” in different directions, such as forward, aft, left and right on a vehicle. By adjusting the net forces created by each of the apparatuses disposed around the vehicle, one may propel and steer the vehicle in any desired direction of travel in two dimensions.

Moreover, while propulsion and steering may be useful in two-dimensions, it is further contemplated that propulsion and steering may also be useful in three-dimensions. By incorporating a plurality of the apparatuses described herein forward, aft, right and left, as well as on top and at a bottom of a vehicle, one may control a vehicle in three-dimensional space. This may be particularly useful for propelling and steering spacecraft or submarines.

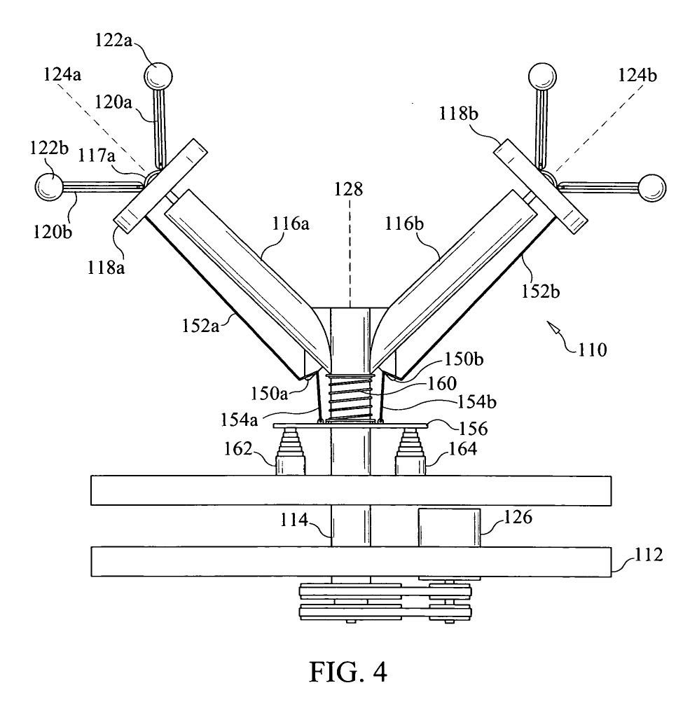

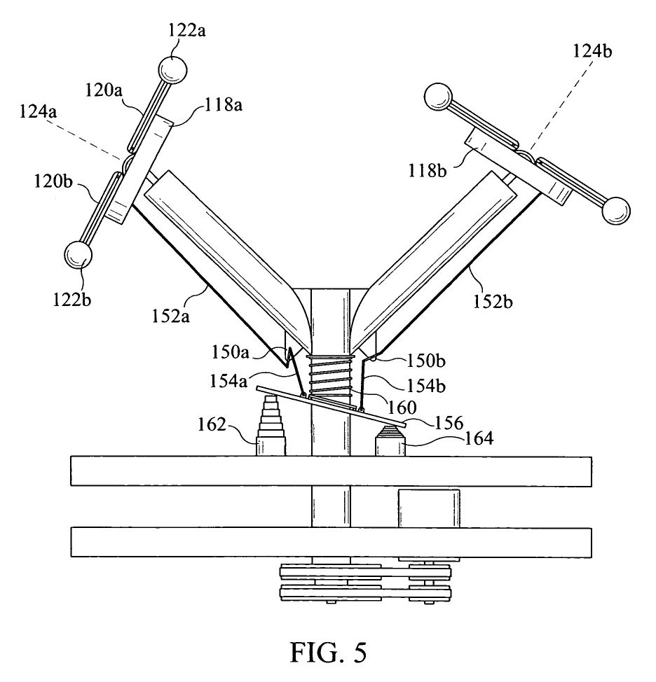

In an alternate embodiment of the present invention, illustrated in FIGS. 4 and 5, a side view of an apparatus 110 is illustrated. The apparatus 110 may have a base 112, a shaft 114 and a plurality of arms 116a, 116b. Although the apparatus 110 merely shows two arms, 116a, 116b, more arms may be disposed on the shaft 114, not shown. Further, attached to each of the arms 116a, 116b are discs 118a, 118b. Again, a plurality of discs may be provided on arms that are not shown in FIG. 4. Further attached to the arm 116a may be rods 120a, 120b with weights 122a, 122b disposed thereon, connected to the arm 116a via connector 117a. For purposes of illustration, only one of the arms 116a, 116b will be discussed herein, with respect to the rods and weights, but it should be noted that the arm not described herein also may have the rods and weights disposed thereon in a manner similar to, if not the same, as the arm described.

As illustrated, the apparatus 110 rotates the connector 117a, thereby rotating the rods 120a, 120b and weights 122a, 122b about the axis 124a. The rods 120a, 120b and weights 122a, 122b, may be rotated by the motor 126. In addition, the shaft 114 is rotated by the motor 126. As in the apparatus 10, illustrated and described with respect to FIGS. 1-3, a single motor may be utilized, or a plurality of motors as apparent to one having ordinary skill in the art.

Changing the angle that each disc 118a and/or 118b (or any other disc disposed thereon) may have with respect to the apparatus 110, one may change the relative positions of the rods and, hence, the weights, as the rods and weights on each of the arms may be rotating. Specifically, as the arms 116a, 116b may rotate about central axis 128, the angles of the discs 118a, 118b may change at certain positions around the shaft 114. For example, the angle of the discs 118a, 118b may be disposed at a different angles relative to the central axis 128 when on a right side of the shaft 114 than on the left side of the shaft 114. This is illustrated in FIG. 5, and described in more detail below. Changing of the angles of the discs 118a, 118b may cause a change in the relative positions of the axes of rotations 124a, 124b, with respect to the central axis 128.

This may cause a change in the net force, thereby causing a force in a direction other than the vertical direction, allowing for steering. Specifically, by changing the angle of the discs as the discs rotate about the shaft 114, one may change the force from a straight up vertical direction to a vertical and a horizontal direction. This may allow steering by changing the angle of one or more discs on the apparatus 110. Therefore, each disc 118a, 118b may include a lever 150a, 150b. Each of the levers 150a, 150b may be connected to lines 152a, 152b that may contact or otherwise be connected to the discs 118a, 118b. A second line 154a, 154b may run from each of the levers 150a, 150b to a platform 156 held downwards by a spring 160 disposed around the shaft 114 and held in place with telescoping holders 162, 164.

When steering of the apparatus and, consequently, a vehicle attached to the apparatus, may be desired of the apparatus 110, the levers 150a, 150b may be adjusted to change the angle of each of the discs 118a, 118b in certain positions as the discs may be rotated about the central axis 128. As illustrated in FIG. 5, when each of the discs 118a, 118b may move to the right-most position, relative to the position of the apparatus 110, as illustrated in FIGS. 4 and 5, the discs 118a, 118b may change their angles, thereby changing the positions of the axes of rotation 124a, 124b. When the discs 118a, 118b may rotate around the shaft and may change their relative positions, the angles of the discs 118a, 118b may change, thereby changing the axes of rotation 124a, 124b. By changing the angle of each of the discs 118a, 118b, the gyroscopes that may be created by the rotating rods and weights may be disposed in a slightly different position, thereby affecting the direction of the net force created when the shaft 114 rotates.

Specifically, FIG. 5 illustrates this concept. Pulling the platform 156 down on one side may push the telescoping holder 164 downwardly and the telescoping holder 162 upwardly. This may cause the levers 150a, 150b to change their positions, ultimately causing the discs 118a, 118b to change their angles relative to the apparatus 110. When the discs 118a, 118b may be rotating about the central axis 128, the net force generated by the apparatus 110 may be deflected to the side so the net force has both a vertical and a horizontal component. This may be used to steer the apparatus and, hence, a vehicle having the apparatus attached thereto, in a desired direction. The telescoping holders 162, 164 may be pulled downwardly and/or pushed upwardly via manual movement of the platform 156, via hydraulics, or via some other control mechanism apparent to one having ordinary skill in the art.

Also shown in FIG. 5 are the hinged rods 120a, 120b with the rods lying 180° from each other, pushed into that position by the centrifugal forces acting upon the rods and weights by rotation of the disc 118a, the rods 120a, 120b and the weights 122a, 122b. Depending on the angle of the discs 118a, 118b as the discs rotate around the central axis 128, the rods and weights disposed on each of the arms 116a, 116b may be disposed in different positions. It may be that the rods would naturally fall to an angle less than 180°.

Other embodiments, not shown by the present invention, include a plurality of apparatuses that may be stacked upon each other in the vertical direction along one or more shafts to provide a greater net force when the rods and weights, as well as the shafts, rotate.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A gyroscopic propulsion and steering apparatus comprising:
a base;
a shaft disposed longitudinally from the base, the shaft being rotatable about a central axis; and
a plurality of arms disposed laterally from the shaft, each arm having a group of rods disposed on the end thereof, each rod having a weight disposed on the end thereof, wherein each of the groups of rods and weights has a respective axis of rotation and further wherein each of the groups of rods and the weights thereon rotate around its respective axis.

2. The apparatus of claim 1 further comprising:
a motor for rotating each of the groups of rods and weights.

3. The apparatus of claim 1 further comprising:
a motor for rotating the shaft.

4. The apparatus of claim 1 further comprising:
a motor for rotating both each of the groups of rods and weights and for rotating the shaft.

5. The apparatus of claim 1 further wherein each of the arms is positioned equidistantly around the shaft.

6. The apparatus of claim 1 further comprising:
a lever connected to each group of rods and weights for changing the position of the respective axis of rotation for each of the groups of rods and weights.

7. The apparatus of claim 1 further wherein the shaft is disposed through the base and rotates while the base remains stationary with respect to the shaft.

8. A gyroscopic propulsion and steering system comprising:
a vehicle; and
a gyroscopic propulsion and steering apparatus comprising a base attached to the vehicle, a shaft disposed longitudinally from the base, a plurality of arms disposed laterally from the shaft, each arm having a group of rods disposed on the end thereof, each rod having a weight disposed on the end thereof, wherein each of the groups of rods and the weights has a respective axis of rotation and further wherein each of the groups of rods and the weights thereon rotates around its respective axis.

9. The system of claim 8 wherein the apparatus further comprises a motor for rotating each of the groups of rods and weights.

10. The system of claim 8 wherein the apparatus further comprises a motor for rotating the shaft.

11. The system of claim 8 wherein the apparatus further comprises a motor for rotating the shaft and each of the groups of rods and weights.

12. The system of claim 8 wherein each of the arms is positioned equidistantly around the shaft.

13. The system of claim 8 further comprising:
a lever connected to each group of rods and weights for changing the position of the respective axis of rotation for each of the groups of rods and weights.

14. The system of claim 8 wherein the shaft is disposed through the base and rotates while the base remains stationary with respect to the shaft.

15. A method of propelling and steering a vehicle comprising the steps of:
providing a gyroscopic propulsion and steering apparatus attached to a vehicle, the apparatus comprising a base attached to the vehicle, a shaft disposed longitudinally from the base and having a central axis of rotation, a plurality of arms disposed laterally from the shaft, each arm having a group of rods disposed on the end thereof, each rod having a weight disposed on the end thereof, wherein each of the groups of rods and the weights has an axis of rotation;
rotating the plurality of groups of rods and weights around each respective axis; and
rotating the shaft around the central axis.

16. The method of claim 15 further comprising:
providing a motor mechanically connected to the plurality of groups of rods and weights; and
rotating the plurality of groups of rods and weights via the motor.

17. The method of claim 15 wherein the apparatus has a top and further wherein the method comprises:
disposing the top of the apparatus in a first direction to propel the vehicle in the first direction.

18. The method of claim 15 wherein each of the groups of rods and weights has a lever for changing the position of each respective axis of rotation for the groups of rods and weight, and further wherein the method comprises:
changing the positions of the respective axes of rotation to propel the apparatus in a direction.

19. The method of claim 15 further comprising:
disposing a second gyroscopic propulsion and steering apparatus attached to the vehicle, the apparatus comprising a base attached to the vehicle, a shaft disposed longitudinally from the base, a plurality of arms disposed laterally from the shaft, each arm having a group of rods disposed on the end thereof, each rod having a weight disposed on the end thereof, wherein each of the groups of rods and the weights has an axis of rotation and further wherein each of the groups of rods and the weights thereon rotate around its respective axis;
propelling the vehicle in a first direction using the first apparatus; and
propelling the vehicle in a second direction using the second apparatus.

20. The method of claim 15 further comprising:
disposing a plurality of gyroscopic propulsion and steering apparatuses in the vehicle, wherein each of the apparatuses comprises a base attached to the vehicle, a shaft disposed longitudinally from the base, a plurality of arms disposed laterally from the shaft, each arm having a group of rods disposed on the end thereof, each rod having a weight disposed on the end thereof, wherein each of the groups of rods and the weights has an axis of rotation and further wherein each of the groups of rods and the weights thereon rotate around its respective axis; and
steering the vehicle through three-dimensional space using the plurality of apparatuses.
